(19) United States
(12) Patent Application Publication
(10) Pub. No.: US 2006/0269086 A1
(43) Pub. Date: Nov. 30, 2006

(54) Audio processing

(76) Inventors: Jason Anthony Page, Buckinghamshire (GB); Oliver George Hume, London (GB); Nicholas Kennedy, London (GB); Paul Scargill, London (GB)

Correspondence Address: KATTEN MUCHIN ROSENMAN LLP, 575 MADISON AVENUE, NEW YORK, NY, 10022-2585, US

(21) Appl. No.: 11/430,271

(22) Filed: May 8, 2006

(30) Foreign Application Priority Data
May 9, 2005 (GB) 0509425.5

(51) Int. Cl. H04B 1/00

(52) U.S. Cl. 381/119

(57) ABSTRACT

An audio processing apparatus operable to mix a plurality of input audio streams to form an output audio stream, the apparatus comprising: a mixer operable to receive the input audio streams and to output a mixed frequency-based audio stream in a frequency-based representation; and a frequency-to-time converter operable to convert the mixed frequency-based audio stream from the frequency-based representation to a time-based representation to form the output audio stream.

### BACKGROUND OF THE INVENTION

1. Field of the Invention

This invention relates to audio processing.

2. Description of the Prior Art

It is known to perform a variety of processing techniques on an audio stream. Examples of such audio processing include filtering, compression, equalisation and volume control. Current audio processors process an audio stream in the time-domain, i.e. for analogue audio processing, they processing audio data as a time-varying voltage whilst for digital audio processing, they process audio data as a sequence of time-wise consecutive audio samples. Depending upon the particular processing that is required, an audio processor may temporarily convert the audio data of an input audio stream from the time-domain to the frequency-domain, perform a specific piece of processing and then return the processed audio data to the time-domain. For a given sequence of processing steps, it may be necessary to perform a number of time-domain processing steps interleaved with a number of frequency-domain processing steps. Consequently a large number of conversions to and from the time- and frequency-domains may be necessary.

It is also known to perform mixing of audio streams, in which two or more input audio streams are combined together to form a single output audio stream. This may arise, for example, in an interview situation where a number of people are provided with their own personal microphones. As another example, many microphones are used at a musical concert or a sports event and the audio streams that they generate are mixed together, often with an additional audio stream for a commentator, to produce a single output stream for broadcast. Mixing is a time-domain process.

### SUMMARY OF THE INVENTION

According to one aspect of the present invention there is provided an audio processing apparatus operable to mix a plurality of input audio streams to form an output audio stream, the apparatus comprising: a mixer operable to receive the input audio streams and to output a mixed frequency-based audio stream in a frequency-based representation; and a frequency-to-time converter operable to convert the mixed frequency-based audio stream from the frequency-based representation to a time-based representation to form the output audio stream.

Embodiments of the invention have an advantage in that all of the input audio streams are converted into the frequency-domain at the first instance. All of the audio mixing and processing is then performed in the frequency-domain. The processed and mixed audio stream is then converted from the frequency-domain to the time-domain for output. As such, the need for multiple consecutive conversions to and from the time and frequency-domains is avoided. This allows a reduction in the amount of hardware required to perform the audio processing whilst at the same time reducing the latency through the system that would otherwise have been caused by such multiple conversions.

Further respective aspects and features of the invention are defined in the appended claims.

### BRIEF DESCRIPTION OF THE DRAWINGS

The above and other objects, features and advantages of the invention will be apparent from the following detailed description of illustrative embodiments which is to be read in connection with the accompanying drawings, in which:

FIG. 1 schematically illustrates the overall system architecture of the PlayStation2 (RTM) games machine as an example of an audio processing apparatus:

FIG. 2 schematically illustrates the architecture of an Emotion Engine;

FIG. 3 schematically illustrates the configuration of a Graphics Synthesiser;

FIG. 4 schematically illustrates an example of audio mixing;

FIG. 5 schematically illustrates another example of audio mixing; and

FIG. 6 schematically illustrates audio mixing and processing according to an embodiment of the invention.

### DESCRIPTION OF THE PREFERRED EMBODIMENTS

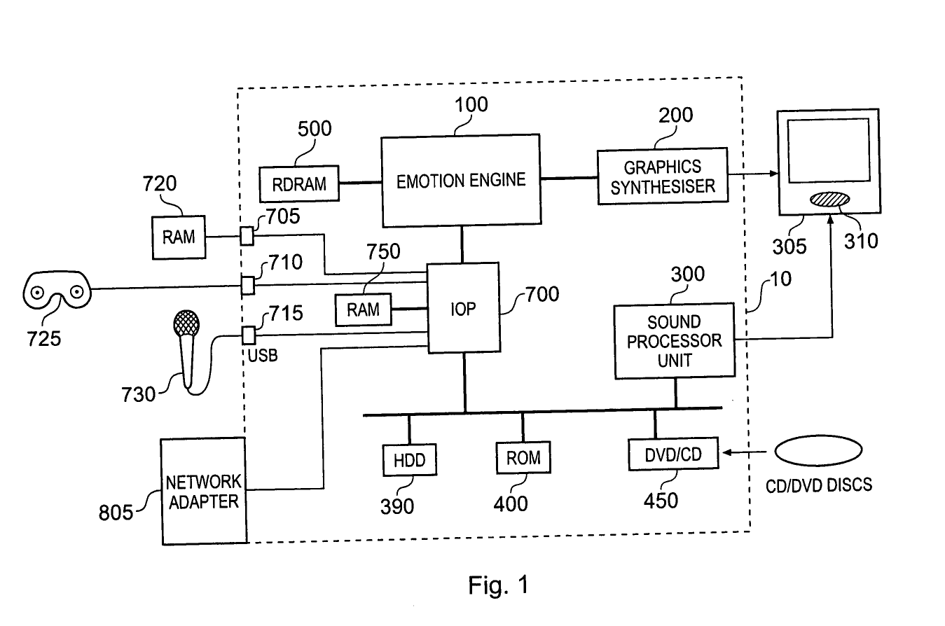

FIG. 1 schematically illustrates the overall system architecture of the PlayStation2 games machine. However, it will be appreciated that embodiments of the invention are not limited to the PlayStation2 games machine.

A system unit 10 is provided, with various peripheral devices connectable to the system unit.

The system unit 10 comprises: an Emotion Engine 100; a Graphics Synthesiser 200; a sound processor unit 300 having dynamic random access memory (DRAM); a read only memory (ROM) 400; a compact disc (CD) and digital versatile disc (DVD) reader 450; a Rambus Dynamic Random Access Memory (RDRAM) unit 500; an input/output processor (IOP) 700 with dedicated RAM 750. An (optional) external hard disk drive (HDD) 390 may be connected.

The input/output processor 700 has two Universal Serial Bus (USB) ports 715 and an iLink or IEEE 1394 port (iLink is the Sony Corporation implementation of the IEEE 1394 standard). The IOP 700 handles all USB, iLink and game controller data traffic. For example when a user is playing a game, the IOP 700 receives data from the game controller and directs it to the Emotion Engine 100 which updates the current state of the game accordingly. The IOP 700 has a Direct Memory Access (DMA) architecture to facilitate rapid data transfer rates. DMA involves transfer of data from main memory to a device without passing it through the CPU. The USB interface is compatible with Open Host Controller Interface (OHCI) and can handle data transfer rates of between 1.5 Mbps and 12 Mbps. Provision of these interfaces means that the PlayStation2 is potentially compatible with peripheral devices such as video cassette recorders (VCRs), digital cameras, microphones, set-top boxes, printers, keyboard, mouse and joystick.

Generally, in order for successful data communication to occur with a peripheral device connected to a USB port 715, an appropriate piece of software such as a device driver should be provided. Device driver technology is very well known and will not be described in detail here, except to say that the skilled man will be aware that a device driver or similar software interface may be required in the embodiment described here.

In the present embodiment, a USB microphone 730 is connected to the USB port. It will be appreciated that the USB microphone 730 may be a hand-held microphone or may form part of a head-set that is worn by the human operator. The advantage of wearing a head-set is that the human operator's hand are free to perform other actions. The microphone includes an analogue-to-digital converter (ADC) and a basic hardware-based real-time data compression and encoding arrangement, so that audio data are transmitted by the microphone 730 to the USB port 715 in an appropriate format, such as 16-bit mono PCM (an uncompressed format) for decoding at the PlayStation 2 system unit 10.

Apart from the USB ports, two other ports 705, 710 are proprietary sockets allowing the connection of a proprietary non-volatile RAM memory card 720 for storing game-related information, a hand-held game controller 725 or a device (not shown) mimicking a hand-held controller, such as a dance mat.

The system unit 10 may be connected to a network adapter 805 that provides an interface (such as an Ethernet interface) to a network. This network may be, for example, a LAN, a WAN or the Internet. The network may be a general network or one that is dedicated to game related communication. The network adapter 805 allows data to be transmitted to and received from other system units 10 that are connected to the same network, (the other system units 10 also having corresponding network adapters 805).

The Emotion Engine 100 is a 128-bit Central Processing Unit (CPU) that has been specifically designed for efficient simulation of 3 dimensional (3D) graphics for games applications. The Emotion Engine components include a data bus, cache memory and registers, all of which are 128-bit. This facilitates fast processing of large volumes of multi-media data. Conventional PCs, by way of comparison, have a basic 64-bit data structure. The floating point calculation performance of the PlayStation2 is 6.2 GFLOPs. The Emotion Engine also comprises MPEG2 decoder circuitry which allows for simultaneous processing of 3D graphics data and DVD data. The Emotion Engine performs geometrical calculations including mathematical transforms and translations and also performs calculations associated with the physics of simulation objects, for example, calculation of friction between two objects. It produces sequences of image rendering commands which are subsequently utilised by the Graphics Synthesiser 200. The image rendering commands are output in the form of display lists. A display list is a sequence of drawing commands that specifies to the Graphics Synthesiser which primitive graphic objects (e.g. points, lines, triangles, sprites) to draw on the screen and at which co-ordinates. Thus a typical display list will comprise commands to draw vertices, commands to shade the faces of polygons, render bitmaps and so on. The Emotion Engine 100 can asynchronously generate multiple display lists.

The Graphics Synthesiser 200 is a video accelerator that performs rendering of the display lists produced by the Emotion Engine 100. The Graphics Synthesiser 200 includes a graphics interface unit (GIF) which handles, tracks and manages the multiple display lists. The rendering function of the Graphics Synthesiser 200 can generate image data that supports several alternative standard output image formats, i.e., NTSC/PAL, High Definition Digital TV and VESA. In general, the rendering capability of graphics systems is defined by the memory bandwidth between a pixel engine and a video memory, each of which is located within the graphics processor. Conventional graphics systems use external Video Random Access Memory (VRAM) connected to the pixel logic via an off-chip bus which tends to restrict available bandwidth. However, the Graphics Synthesiser 200 of the PlayStation2 provides the pixel logic and the video memory on a single high-performance chip which allows for a comparatively large 38.4 Gigabyte per second memory access bandwidth. The Graphics Synthesiser is theoretically capable of achieving a peak drawing capacity of 75 million polygons per second. Even with a full range of effects such as textures, lighting and transparency, a sustained rate of 20 million polygons per second can be drawn continuously. Accordingly, the Graphics Synthesiser 200 is capable of rendering a film-quality image.

The Sound Processor Unit (SPU) 300 is effectively the soundcard of the system which is capable of recognising 3D digital sound such as Digital Theater Surround (DTS®) sound and AC-3 (also known as Dolby Digital) which is the sound format used for DVDs.

A display and sound output device 305, such as a video monitor or television set with an associated loudspeaker arrangement 310, is connected to receive video and audio signals from the graphics synthesiser 200 and the sound processing unit 300.

The main memory supporting the Emotion Engine 100 is the RDRAM (Rambus Dynamic Random Access Memory) module 500 produced by Rambus Incorporated. This RDRAM memory subsystem comprises RAM, a RAM controller and a bus connecting the RAM to the Emotion Engine 100.

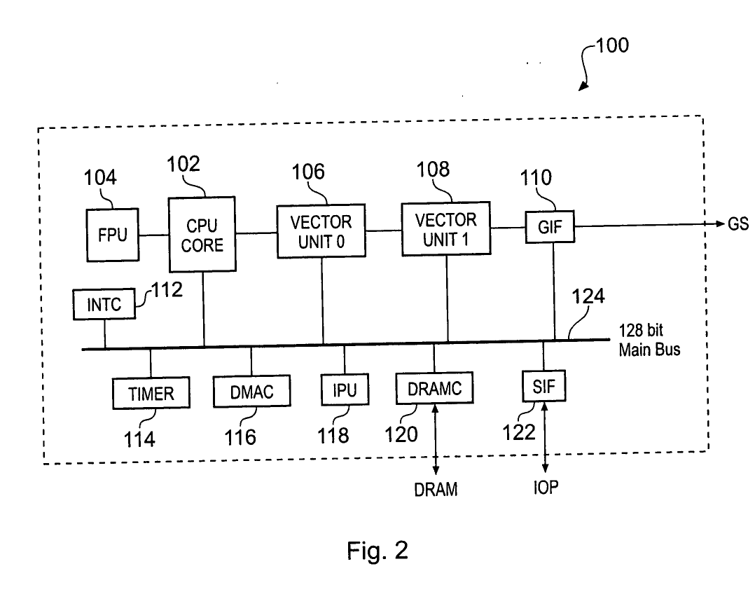

FIG. 2 schematically illustrates the architecture of the Emotion Engine 100 of FIG. 1. The Emotion Engine 100 comprises: a floating point unit (FPU) 104; a central processing unit (CPU) core 102; vector unit zero (VU0) 106; vector unit one (VU1) 108; a graphics interface unit (GIF) 110; an interrupt controller (INTC) 112; a timer unit 114; a direct memory access controller 116; an image data processor unit (IPU) 118; a dynamic random access memory controller (DRAMC) 120; a sub-bus interface (SIF) 122; and all of these components are connected via a 128-bit main bus 124.

The CPU core 102 is a 128-bit processor clocked at 300 MHz. The CPU core has access to 32 MB of main memory via the DRAMC 120. The CPU core 102 instruction set is based on MIPS III RISC with some MIPS IV RISC instructions together with additional multimedia instructions. MIPS III and IV are Reduced Instruction Set Computer (RISC) instruction set architectures proprietary to MIPS Technologies, Inc. Standard instructions are 64-bit, two-way superscalar, which means that two instructions can be executed simultaneously. Multimedia instructions, on the other hand, use 128-bit instructions via two pipelines. The CPU core 102 comprises a 16 KB instruction cache, an 8 KB data cache and a 16 KB scratchpad RAM which is a portion of cache reserved for direct private usage by the CPU.

The FPU 104 serves as a first co-processor for the CPU core 102. The vector unit 106 acts as a second co-processor. The FPU 104 comprises a floating point product sum arithmetic logic unit (FMAC) and a floating point division calculator (FDIV). Both the FMAC and FDIV operate on 32-bit values so when an operation is carried out on a 128-bit value ( composed of four 32-bit values) an operation can be carried out on all four parts concurrently. For example adding 2 vectors together can be done at the same time.

The vector units 106 and 108 perform mathematical operations and are essentially specialised FPUs that are extremely fast at evaluating the multiplication and addition of vector equations. They use Floating-Point Multiply-Adder Calculators (FMACs) for addition and multiplication operations and Floating-Point Dividers (FDIVs) for division and square root operations. They have built-in memory for storing micro-programs and interface with the rest of the system via Vector Interface Units (VIFs). Vector unit zero 106 can work as a coprocessor to the CPU core 102 via a dedicated 128-bit bus so it is essentially a second specialised FPU. Vector unit one 108, on the other hand, has a dedicated bus to the Graphics synthesiser 200 and thus can be considered as a completely separate processor. The inclusion of two vector units allows the software developer to split up the work between different parts of the CPU and the vector units can be used in either serial or parallel connection.

Vector unit zero 106 comprises 4 FMACS and 1 FDIV. It is connected to the CPU core 102 via a coprocessor connection. It has 4 Kb of vector unit memory for data and 4 Kb of micro-memory for instructions. Vector unit zero 106 is useful for performing physics calculations associated with the images for display. It primarily executes non-patterned geometric processing together with the CPU core 102.

Vector unit one 108 comprises 5 FMACS and 2 FDIVs. It has no direct path to the CPU core 102, although it does have a direct path to the GIF unit 110. It has 16 Kb of vector unit memory for data and 16 Kb of micro-memory for instructions. Vector unit one 108 is useful for performing transformations. It primarily executes patterned geometric processing and directly outputs a generated display list to the GIF 110.

The GIF 110 is an interface unit to the Graphics Synthesiser 200. It converts data according to a tag specification at the beginning of a display list packet and transfers drawing commands to the Graphics Synthesiser 200 whilst mutually arbitrating multiple transfer. The interrupt controller (INTC) 112 serves to arbitrate interrupts from peripheral devices, except the DMAC 116.

The timer unit 114 comprises four independent timers with 16-bit counters. The timers are driven either by the bus clock (at 1/16 or 1/256 intervals) or via an external clock. The DMAC 116 handles data transfers between main memory and peripheral processors or main memory and the scratch pad memory. It arbitrates the main bus 124 at the same time. Performance optimisation of the DMAC 116 is a key way by which to improve Emotion Engine performance. The image processing unit (IPU) 118 is an image data processor that is used to expand compressed animations and texture images. It performs I-PICTURE Macro-Block decoding, colour space conversion and vector quantisation. Finally, the sub-bus interface (SIF) 122 is an interface unit to the IOP 700. It has its own memory and bus to control I/O devices such as sound chips and storage devices.

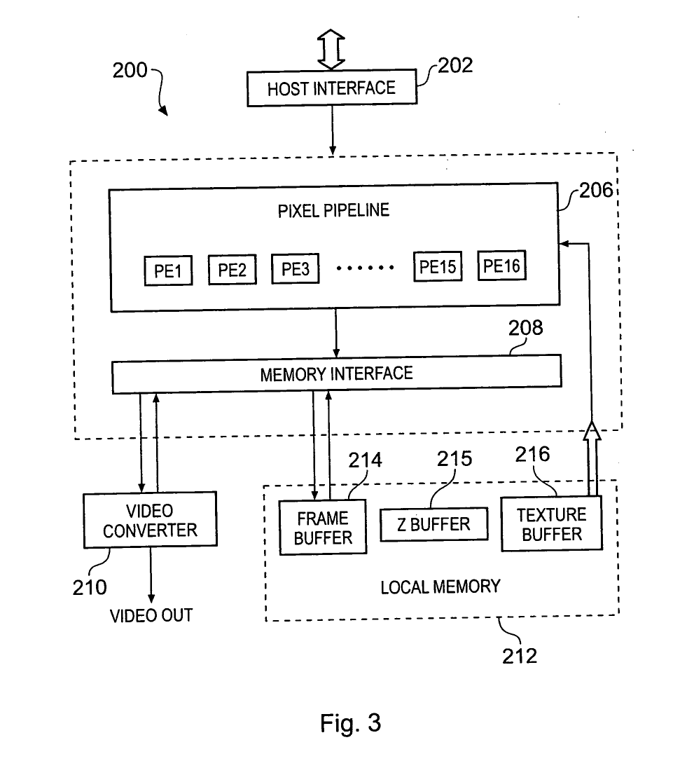

FIG. 3 schematically illustrates the configuration of the Graphic Synthesiser 200. The Graphics Synthesiser comprises: a host interface 202; a set-up/rasterizing unit; a pixel pipeline 206; a memory interface 208; a local memory 212 including a frame page buffer 214 and a texture page buffer 216; and a video converter 210.

The host interface 202 transfers data with the host (in this case the CPU core 102 of the Emotion Engine 100). Both drawing data and buffer data from the host pass through this interface. The output from the host interface 202 is supplied to the graphics synthesiser 200 which develops the graphics to draw pixels based on vertex information received from the Emotion Engine 100, and calculates information such as RGBA value, depth value (i.e. Z-value), texture value and fog value for each pixel. The RGBA value specifies the red, green, blue (RGB) colour components and the A (Alpha) component represents opacity of an image object. The Alpha value can range from completely transparent to totally opaque. The pixel data is supplied to the pixel pipeline 206 which performs processes such as texture mapping, fogging and Alpha-blending and determines the final drawing colour based on the calculated pixel information.

The pixel pipeline 206 comprises 16 pixel engines PE1, PE2, . . . , PE16 so that it can process a maximum of 16 pixels concurrently. The pixel pipeline 206 runs at 150 MHz with 32-bit colour and a 32-bit Z-buffer. The memory interface 208 reads data from and writes data to the local Graphics Synthesiser memory 212. It writes the drawing pixel values (RGBA and Z) to memory at the end of a pixel operation and reads the pixel values of the frame buffer 214 from memory. These pixel values read from the frame buffer 214 are used for pixel test or Alpha-blending. The memory interface 208 also reads from local memory 212 the RGBA values for the current contents of the frame buffer. The local memory 212 is a 32 Mbit (4 MB) memory that is built-in to the Graphics Synthesiser 200. It can be organised as a frame buffer 214, texture buffer 216 and a 32-bit Z-buffer 215. The frame buffer 214 is the portion of video memory where pixel data such as colour information is stored.

The Graphics Synthesiser uses a 2D to 3D texture mapping process to add visual detail to 3D geometry. Each texture may be wrapped around a 3D image object and is stretched and skewed to give a 3D graphical effect. The texture buffer is used to store the texture information for image objects. The Z-buffer 215 (also known as depth buffer) is the memory available to store the depth information for a pixel. Images are constructed from basic building blocks known as graphics primitives or polygons. When a polygon is rendered with Z-buffering, the depth value of each of its pixels is compared with the corresponding value stored in the Z-buffer. If the value stored in the Z-buffer is greater than or equal to the depth of the new pixel value then this pixel is determined visible so that it should be rendered and the Z-buffer will be updated with the new pixel depth. If however the Z-buffer depth value is less than the new pixel depth value the new pixel value is behind what has already been drawn and will not be rendered.

The local memory 212 has a 1024-bit read port and a 1024-bit write port for accessing the frame buffer and Z-buffer and a 512-bit-port for texture reading. The video converter 210 is operable to display the contents of the frame memory in a specified output format.

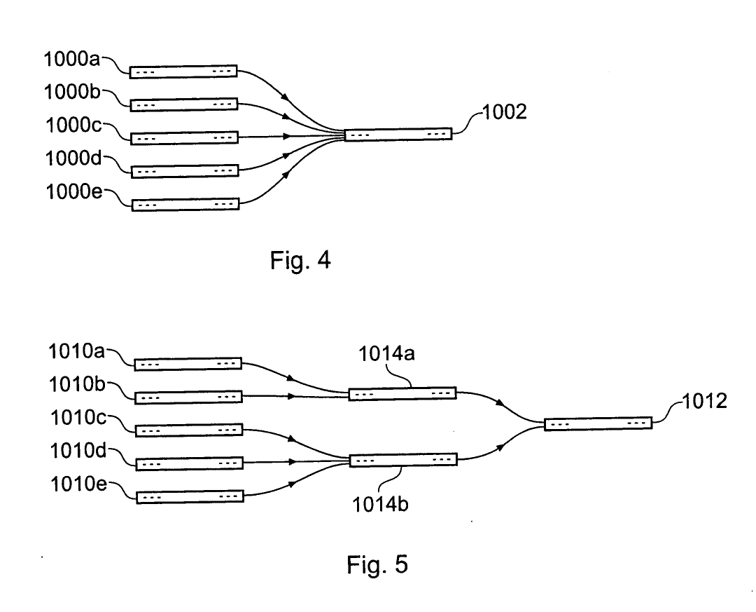

FIG. 4 schematically illustrates an example of audio mixing. Five input audio streams 1000a, 1000b, 1000c, 1000d, 1000e are mixed to produce a single output audio stream 1002. This mixing is performed by the sound processor unit 300. The input audio streams 1000 may come from a variety of sources, such as one or more microphones 730 and/or a CD/DVD disk as read by the reader 450. Although FIG. 4 does not show any audio processing being performed on the input audio streams 1000 or on the output audio stream 1002 other than the mixing of the input audio streams 1000, it will be appreciated that the sound processor unit 300 may perform a variety of other audio processing steps. It will also be appreciated that whilst FIG. 4 shows five input audio streams 1000 being mixed to produce a single output audio stream 1002, any other number of input audio streams 1000 could be used.

FIG. 5 schematically illustrates another example of audio mixing that may be performed by the sound processing unit 300. In a similar way to that shown in FIG. 4, five input audio streams 1010a, 1010b, 1010c, 1010d, 1010e are mixed together to form a single output audio stream 1012. However, as shown in FIG. 5, an intermediate stage of mixing is performed by the sound processor unit 300. Specifically, two input audio streams 1010a, 1010b are mixed to produce a preliminary audio stream 1014a, whilst the remaining three input audio streams 1010c, 1010d, 1010e are mixed to produce a preliminary audio stream 1014b. The preliminary audio streams 1014a and 1014b are then mixed to produce the output audio stream 1012. One advantage of the mixing operation shown in FIG. 5 over that shown in FIG. 4 is that if some of the input audio streams 1010, such as the first two input audio streams 1010a, 1010b, each require the same audio processing to be performed, then they may be mixed together to form a single preliminary audio stream 1014a on which that audio processing may be performed. In this way, a single audio processing step is performed on the single preliminary audio stream 1014a, rather than having to perform two audio processing steps, one on each of the input audio streams 1010a, 1010b. This therefore makes for more efficient audio processing.

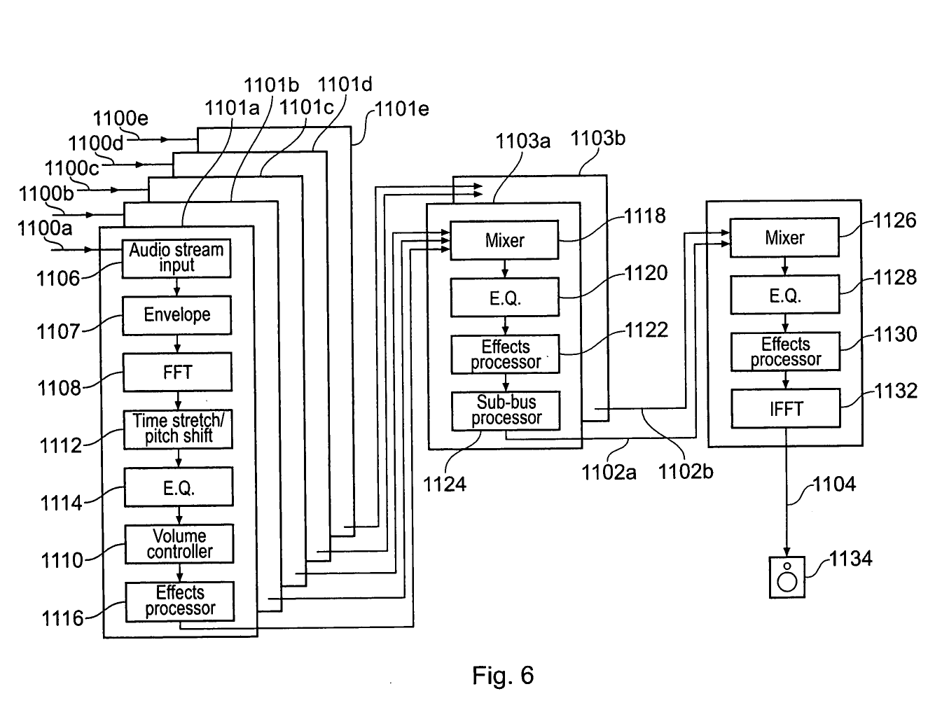

FIG. 6 schematically illustrates audio mixing and processing according to an embodiment of the invention. Three input audio streams 1100a, 1100b, 1100c are mixed to produce a preliminary audio stream 1102a. Two other input audio streams 1100d, 1111e are mixed to produce another preliminary audio stream 1102b. The preliminary audio streams 1102a, 1102b are then mixed to produce an output audio stream 1104. It will be appreciated that whilst FIG. 6 illustrates three input audio streams 1100a, 1100b, 1100c being mixed to form one of the preliminary audio streams 1102a and shows two different input audio streams 1100d, 1100e being mixed to form a separate preliminary audio stream 1102b, the actual configuration of the mixing may vary in dependence upon the particular requirements of the audio processing. Indeed, there may be a different number of input audio streams 1100 and a different number of preliminary audio streams 1102. Furthermore, one or more of the input audio streams 1100 may contribute to two or more of the preliminary audio streams 1102.

Each of the input audio streams 1100a, 1100b, 1100c, 1100d, 1100e may comprise one or more audio channels.

The initial processing performed on an individual input audio stream 1100 will now be described. Each of the input audio streams 1100a, 1100b, 1100c, 1100d, 1100e is processed by a respective processor 1101a, 1101b, 1101c, 1101d, 1101e which may be implemented as part of the functionality of the PlayStation 2 games machine described above, as respective stand-alone digital signal processors, as software-controlled operations of a general data processor capable of handling multiple concurrent operations, and so on. It will of course be appreciated that the PlayStation2 games machine is merely a useful example of an apparatus which could perform some or all of this functionality.

An input audio stream 1100 is received at an input 1106 of the corresponding processor 1101. The input audio stream 1100 may be received from a CD/DVD disk via the reader 450 or it may be received via the microphone 730 for example. Alternatively, the input audio stream 1100 may be stored in a RAM (such as the RAM 720).

The envelope of the input audio stream 1100 is modified/shaped by the envelope processor 1107.

A fast Fourier transform (FFT) processor 1108 then transforms the input audio stream 1100 from the time-domain to the frequency-domain. If the input audio stream 1100 comprises one or more audio channels, the FFT processor applies an FFT to each of the channels separately. The FFT processor 1108 may operate with any appropriately sized window of audio samples. Preferred embodiments use a window size of 1024 samples with the input audio stream 1100 having been sampled at 48 kHz. The FFT processor 1108 may output either floating point frequency-domain samples or frequency-domain samples that are limited to a fixed bit-width. It will be appreciated that whilst the FFT processor 1108 makes use of a FFT to transform the input audio stream from the time-domain to the frequency-domain, any other time-domain to frequency-domain transformation may be used.

It will be appreciated that the input audio stream 1100 may be supplied to the processor 1101 as frequency-domain data. For example, the input audio stream 1100 may have been initially created in the frequency-domain. In this case, the FFT processor 1108 is bypassed, the FFT processor 1108 only being used when the processor 1101 receives an input audio stream 1100 in the time-domain.

An audio processing unit 1112 then performs various audio processing on the frequency-domain converted input audio stream 1100. For example, the audio processing unit 1112 may perform time stretching and/or pitch shifting. When performing time stretching, the playing time of the input audio stream 1100 is altered without changing the actual pitch of the input audio stream 1100. When performing pitch shifting, the pitch of the input audio stream 1100 is altered without changing the playing time of the input audio stream 1100.

Once the audio processing unit 1112 has finished its processing on the frequency-domain converted input audio stream 1100, an equaliser 1114 performs frequency equalisation on the input audio stream 1100. Equalisation is a known technique and will not be described in detail herein.

After the equaliser 1114 has performed equalisation of the frequency-domain converted input audio stream 1100, the frequency-domain converted input audio stream 1100 is then output from the equaliser 1114 to a volume controller 1110. The volume controller 1110 serves to control the level of the input audio stream 1100. The volume controller 1110 may make use of any know technique to control the level of the input audio stream 1100. For example, if the format of the output audio stream 1104 is in 7.1 surround sound, then the volume controller 1110 may generate eight volume parameters, one for each of the corresponding speakers, so that the output volume of the input audio stream 1100 can be controlled on a speaker by speaker basis.

After the volume controller 1110 has performed its volume processing on the frequency-domain converted input audio stream 1100, an effects processor 1116 modifies the frequency-domain converted input audio stream 1100 in a variety of different ways (e.g. via equalisation on each of the audio channels of the input audio stream 1100) and mixes these modified versions together. This is used to generate a variety of effects, such as reverberation.

It will be appreciated that the audio processing performed by the envelope processor 1107, the volume controller 1110, the audio processing unit 1112, the equaliser 1114 and the effects processor 1116 may be performed in any order. Indeed, it is even possible that, for a particular audio processing effect, the processing performed by the envelope processor 1107, the volume controller 1110, the audio processing unit 1112, the equaliser 1114 or the effects processor 1116 may be bypassed. However, all of the processing following the FFT processor 1108 is undertaken in the frequency-domain, using the frequency-domain converted input audio stream 1100 that is produced by the FFT processor 1108.

The audio processing that is applied to each of the input audio streams 1100 may vary from stream to stream.

The generation of a preliminary audio stream 1102 will now be described. Each of the preliminary audio streams 1102a, 1102b is produced by a respective sub-bus 1103a, 1103b.

A mixer 1118 of a sub-bus 1103 receives one or more of the processed input audio streams 1100, represented in the frequency-domain, and produces a mixed version of these processed input audio streams 1100. In FIG. 6, the mixer 1118 of the first sub-bus 1103a receives processed versions of the input audio streams 1100a, 1100b, 1100c. The mixed audio stream is then passed to an equaliser 1120. The equaliser 1120 performs functions similar to the equaliser 1114. The output of the equaliser 1120 is then passed to an effects processor 1122. The processing performed by the effects processor 1122 is similar to the processing performed by the effects processor 1116.

A sub-bus processor 1124 receives the output from the effects processor 1122 and adjusts the level of the output of the effects processor 1122 in accordance with control information received from one or more of the other sub-buses 1103 (often referred to as “ducking” or “side chain compression”). The sub-bus processor 1124 also provides control information to one or more of the other sub-buses 1103 so that those sub-buses 1103 may adjust the level of their preliminary audio streams in accordance with the control information supplied by the sub-bus processor 1124. For example, the preliminary audio stream 1102a may relate to audio from a football match whilst the preliminary audio stream 1102b may relate to commentary for the football match. The sub-bus processor 1124 for each of the preliminary audio streams 1102a and 1102b may work together to adjust the levels of the audio from the football match and the commentary so that the commentary may be faded in and out as appropriate.

Again, it will be appreciated that the audio processing performed by the equaliser 1120, the effects processor 1122 and the sub-bus processor 1124 may be performed in any order. Indeed, it is even possible that, for a particular audio processing effect, the processing performed by the equaliser 1120, the effects processor 1122 and the sub-bus processor 1124 may be bypassed. However, all of the processing is undertaken in the frequency-domain.

The generation of the final output audio stream will now be described. A mixer 1126 receives the preliminary audio streams 1102a and 1102b and mixes them to produce an initial mixed output audio stream. The output of the mixer 1126 is supplied to an equaliser 1128. The equaliser 1128 performs processing similar to that of the equaliser 1120 and the equaliser 1114. The output of the equaliser 1128 is supplied to an effects processor 1130. The effects processor 1130 performs processing similar to that of the effects processor 1122 and the effects processor 1116. Finally, the output of the effects processor 1130 is supplied to an inverse FFT processor 1132. The inverse FFT processor 1132 performs an inverse FFT to reverse the transformation applied by the FFT processor 1108, i.e. to transform the frequency-domain representation of the audio stream output by the effects processor 1130 to the time-domain representation. If the mixed output audio stream comprises one or more audio channels, the inverse FFT processor 1132 applies an inverse FFT to each of the channels separately. The time-domain representation output by the inverse FFT processor 1132 may then be supplied to an appropriate audio apparatus expecting to receive a time-domain audio signal, such as one or more speakers 1134.

It will be appreciated that all of the audio processing performed between the FFT processor 1108 and the inverse FFT processor 1132 is performed in the frequency-domain and not the time-domain. As such, for each of the time-domain input audio streams 1100, there is only ever one transformation from the time-domain to the frequency-domain. Furthermore, there is only ever one transformation from the frequency-domain to the time-domain, and this is performed only for the final mixed output audio stream.

The audio processing performed may be undertaken in software, hardware or a combination of hardware and software. In so far as the embodiments of the invention described above are implemented, at least in part, using software-controlled data processing apparatus, it will be appreciated that a computer program providing such software control and a storage medium by which such a computer program is stored are envisaged as aspects of the present invention.

Although illustrative embodiments of the invention have been described in detail herein with reference to the accompanying drawings, it is to be understood that the invention is not limited to those precise embodiments, and that various changes and modifications can be effected therein by one skilled in the art without departing from the spirit and scope of the invention as defined by the appended claims.

We claim:

1. An audio processing apparatus operable to mix a plurality of input audio streams to form an output audio stream, said apparatus comprising:
a mixer operable to receive said input audio streams and to output a mixed frequency-based audio stream in a frequency-based representation; and
a frequency-to-time converter operable to convert said mixed frequency-based audio stream from said frequency-based representation to a time-based representation to form said output audio stream.

2. An audio processing apparatus according to claim 1, wherein said mixer is operable to receive an input audio stream in said time-based representation, said mixer comprising a time-to-frequency converter operable to convert an input audio stream from said time-based representation to said frequency-based representation.

3. An audio processing apparatus according to claim 1, wherein said mixer is operable to receive input audio streams in said frequency-based representation.

4. An audio processing apparatus according to claim 2, wherein each of said audio streams comprises one or more audio channels.

5. An audio processing apparatus according to claim 4, wherein said time-to-frequency converter is operable to perform a fast Fourier transform on an audio channel of an input audio stream and said frequency-to-time converter is operable to perform an inverse fast Fourier transform on an audio channel of said mixed frequency-based audio stream.

6. An audio processing apparatus according to claim 1, wherein said mixer comprises:
a plurality of sub-mixers, each of said sub-mixers being operable to receive a plurality of intermediate frequency-based audio streams, each of said intermediate frequency-based audio streams corresponding to an input audio stream, and to mix said intermediate frequency-based audio streams to produce a corresponding preliminary frequency-based audio stream; and
a master-mixer operable to mix said preliminary frequency-based audio streams to produce said mixed frequency-based audio stream.

7. An audio processing apparatus according to claim 6, wherein said mixer comprises an effects unit operable to apply an audio effect to an input audio stream in said frequency-based representation and/or said mixed frequency-based audio stream.

8. An audio processing apparatus according to claim 7, wherein said effects unit is operable to apply an audio effect to a preliminary frequency-based audio stream.

9. An audio processing apparatus according to claim 8, wherein said effects unit is operable to control the volume of a preliminary frequency-based audio stream in accordance with the volume of another one of said preliminary frequency-based audio streams.

10. An audio processing apparatus according to claim 7, wherein the audio effect applied by said effects unit comprises one or more of: equalisation; pitch shifting; applying reverberation; controlling volume; compression; and adjusting the envelope of said audio stream.

11. An audio processing apparatus according to claim 1, wherein said frequency-based audio streams are processed as floating-point data.

12. An audio processing method for mixing a plurality of input audio streams to form an output audio stream, said method comprising the steps of:
mixing said input audio streams to output a mixed frequency-based audio stream in a frequency-based representation; and
performing frequency-to-time conversion to convert said mixed frequency-based audio stream from said frequency-based representation to a time-based representation to form said output audio stream.

13. Computer software comprising program code for carrying out an audio processing method according to claim 12.

14. A providing medium for providing computer software according to claim 13.

15. A providing medium having recorded thereon an audio stream produced according an audio processing method according to claim 12.

18. A medium according to claim 14, wherein said medium is a storage medium.

19. A medium according to claim 14, wherein said medium is a transmission medium.

20. A medium according to claim 15, wherein said medium is a storage medium.

21. A medium according to claim 15, wherein said medium is a transmission medium.
